(19) United States
(12) Patent Application Publication
(10) Pub. No.: US 2013/0205358 A1
(43) Pub. Date: Aug. 8, 2013

(54) ELECTRICAL DEVICE HAVING A WIRELESS ROUTE FUNCTION

(71) Applicants: Jiun-Jin Huang, Hsinchu (TW); Shu-Wei Chou, Hsinchu (TW); Chih-Ping Tsou, Hsinchu (TW)

(72) Inventors: Jiun-Jin Huang, Hsinchu (TW); Shu-Wei Chou, Hsinchu (TW); Chih-Ping Tsou, Hsinchu (TW)

(21) Appl. No.: 13/451,238

(22) Filed: Apr. 19, 2012

(30) Foreign Application Priority Data
Feb. 8, 2012 (TW) 101202232

(51) Int. Cl. H04N 21/61

(52) U.S. Cl. 725/127

(57) ABSTRACT

An electrical device having a wireless route function is provided. The electrical device comprises a signal processing module, a wireless route module and a wireless transceiver module electrically connected to the signal processing module and the wireless route module. The signal processing module is configured to generate a first signal. The wireless route module is configured to create a route mode. The wireless transceiver module is configured to build a plurality of first wireless connections with a plurality of first electrical products according to the route mode, and transmit the first signal to the first electrical products via the first wireless connections so that each of the first electrical products executes a first action in response to the first signal.

This application claims priority to Taiwan Patent Application No. 101202232 filed on Feb. 8, 2012, which is hereby incorporated by reference in its entirety.

### CROSS-REFERENCES TO RELATED APPLICATIONS

Not applicable.

### BACKGROUND OF THE INVENTION

1. Field of the Invention

The present invention relates to an electrical device having a wireless route function. More particularly, the present invention relates to an electrical device capable of simultaneously connecting and communicating with a plurality of electrical products via a wireless route function thereof

2. Descriptions of the Related Art

The new concept of wireless networks has evolved as a result of the advancement of wireless communication technologies. On the other hand, with the advancement of wireless communication technologies, there are increasingly more demands for wireless networks. Over recent years, as costs of wireless products have been continuously lowered and the use of wireless communication technologies have become increasingly widespread, wireless networks have become indispensable to the modern people. As compared to conventional wired networks, wireless networks are more flexible and convenient in terms of deployment and operations; and additionally, the problem of poor transmission quality with the early generations of wireless networks has gradually improved. To satisfy the modern people's demands for wireless networks, more service providers are now developing wireless networks that are more adapted to people's demands.

Wireless local area network (WLAN) service is one of the wireless network services that people rely on. In detail, WLAN service refers to a service that provides users with wireless network accessibility within a certain region; i.e., a plurality of wireless apparatuses within this region can connect and communicate with each other wirelessly.

When a wireless apparatus is to connect and communicate with a plurality of other wireless apparatuses within a certain region simultaneously in a WLAN adopting a conventional WLAN technology, a wireless router must be used to provide protocols and modes necessary for the connection and communication to accomplish the WLAN service. Therefore, without the assistance of a wireless router, a wireless apparatus is unable to connect and communicate with a plurality of wireless apparatuses within a certain region simultaneously, but can only perform the so-called point-to-point (P2P) transmission.

Furthermore, the conventional wireless router not only provides the service that allows a plurality of wireless apparatuses to connect and communicate with each other wirelessly within a certain region, but also provides a service that allows wireless apparatuses to access the Internet. However, because WLAN service shares the same bandwidth as the Internet service, the WLAN is liable to congestion due to an excessively large throughput of the Internet, and this makes it impossible for the wireless router to provide a satisfactory WLAN service quality for wireless apparatuses. Moreover, when a large amount of data such as video/audio signals is transmitted between these wireless apparatuses, the distortion or interruption of received signals tends to occur due to network congestion.

On the other hand, because the wireless router can provide the service that allows for a plurality of wireless apparatuses to connect and communicate with each other wirelessly within only a certain region, wireless apparatuses will fail to wirelessly connect and communicate with each other if no wireless router exists within the region where the wireless apparatuses are located. Therefore, since wireless routers are not yet widespread, conventional WLAN technologies are unable to provide WLAN services for users located anywhere and at any time.

Accordingly, it is important to improve the following problems of conventional WLAN technologies: the WLAN is liable to congestion due to an excessive throughput of the Internet and is unable to be accessed conveniently because the deployment of wireless routers is still not as widespread as needed.

### SUMMARY OF THE INVENTION

An objective of the present invention is to provide an electrical device having a wireless route function. Specifically, the electrical device having a wireless route function of the present invention has a wireless route module built therein so that it can wirelessly connect and communicate with a plurality of electrical products simultaneously without the support of a wireless router. The communication content may include but is not limited to bi-directional video/audio messages, bi-directional data messages, bi-directional control messages, etc.

Because the wireless route module is specially used to provide the WLAN connection service, the WLAN is no longer liable to congestion from an excessively large throughput of the Internet. Since the wireless route module is built in the electrical device, a WLAN can be established anywhere and at any time so that the electrical device can wirelessly connect and communicate with the plurality of electrical products.

To achieve the aforesaid objective, the present invention provides an electrical device having a wireless route function. The electrical device comprises a signal processing module, a wireless route module, and a wireless transceiver module electrically connected to the signal processing module and the wireless route module. The signal processing module is configured to generate a first signal. The wireless route module is configured to create a route mode. The wireless transceiver module is configured to build a plurality of first wireless connections with a plurality of first electrical products according to the route mode and transmit the first signal to the first electrical products via the first wireless connections so that each of the first electrical products executes a first action in response to the first signal.

To achieve the aforesaid objective, the present invention further provides an electrical device having a wireless route function. The electrical device comprises a signal processing module, a wireless route module, and a wireless transceiver module electrically connected to the signal processing module and the wireless route module. The wireless route module is configured to create a route mode. The wireless transceiver module is configured to build a plurality of wireless connections with a plurality of electrical products according to the route mode and receive a plurality of signals from the electrical products via the wireless connections. The signal processing module executes an action in response to the signals.

To achieve the aforesaid objective, the present invention further provides an electrical device having a wireless route function. The electrical device comprises a signal processing module, a wireless route module, and a wireless transceiver module electrically connected to the signal processing module and the wireless route module. The signal processing module is configured to generate a first signal. The wireless route module is configured to create a route mode. The wireless transceiver module is configured to build a plurality of first wireless connections with a plurality of first electrical products according to the route mode and transmit the first signal to the first electrical products via the first wireless connections so that each of the first electrical products executes a first action in response to the first signal. The wireless transceiver module is further configured to build a plurality of second wireless connections with a plurality of second electrical products according to the route mode and receive a plurality of second signals from the second electrical products via the second wireless connections. The signal processing module further executes a second action in response to the signals.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating the connections of a WLAN 1 of the present invention;

FIG. 2 is a schematic view illustrating the connections of a WLAN 3 of the present invention; and

FIG. 3 is a schematic view illustrating the connections of a WLAN 5 of the present invention.

### DESCRIPTION OF THE PREFERRED EMBODIMENT

In the following descriptions, the present invention will be explained with reference to embodiments thereof. It shall be appreciated that these embodiments are not intended to limit the present invention to any specific environments, applications or particular implementations described in these embodiments. Therefore, the description of these embodiments is only for the purpose of illustration rather than to limit the present invention, and the scope claimed in this application shall be governed by the claims. Additionally, in the following embodiments and the attached drawings, the elements not directly related to the present invention are omitted from depiction; and the dimensional relationships among individual elements in the attached drawings are illustrated only for the ease of understanding but not to limit the actual scale.

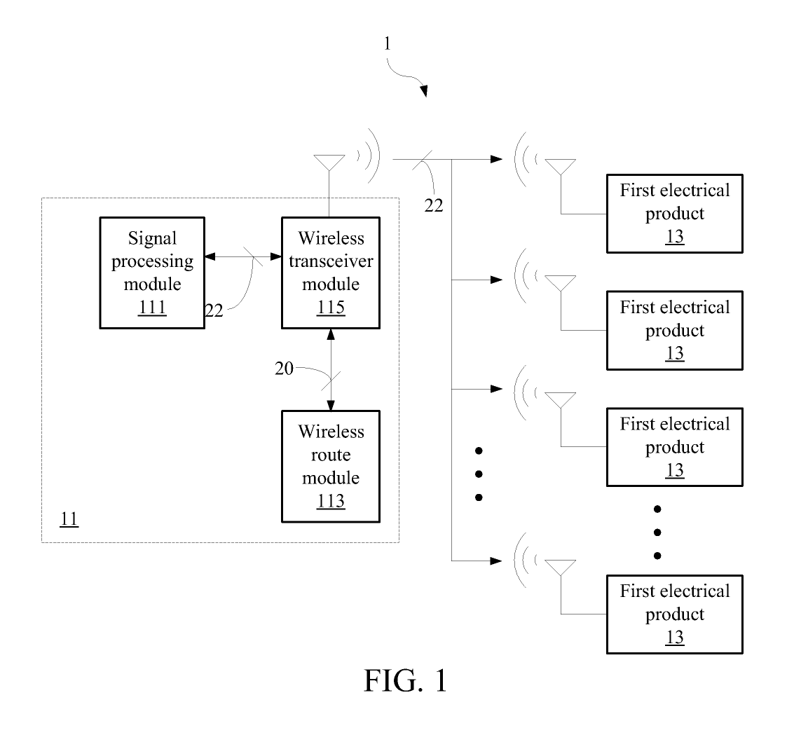

FIG. 1 illustrates the first embodiment of the present invention, which is a WLAN 1. Specifically, FIG. 1 is a schematic view illustrating the connections of the WLAN 1. As shown in FIG. 1, the WLAN 1 comprises an electrical device 11 having a wireless route function and a plurality of first electrical products 13. It shall be appreciated that the first electrical products 13 of FIG. 1 may be electrical apparatuses with a wireless transmitting/receiving function such as smart phones, network televisions (TVs), flat panel/portable computers, handheld multi-media players or wireless video/audio receivers; and the number of the first electrical products 13 is only for the purpose of illustration rather than to limit the present invention.

The electrical device 11 having a wireless route function of this embodiment comprises a signal processing module 111, a wireless route module 113, and a wireless transceiver module 115 electrically connected to the signal processing module 111 and the wireless route module 113. The signal processing module 111, the wireless route module 113 and the wireless transceiver module 115 of this embodiment conform to a Wireless Fidelity (Wi-Fi) standard. Therefore, the signal processing module 111, the wireless route module 113 and the wireless transceiver module 115 can operate within a coverage area of the WLAN 1 according to one of multiple wireless network communication protocols (e.g., IEEE 802.11a/b/g/n/ac). It shall be appreciated that the wireless route module 113 and the wireless transceiver module 115 may also operate according to other wireless network communication protocols in other embodiments, and the present invention is not limited to what is described herein.

Furthermore, the signal processing module 111 generates a first signal 20 according to the Wi-Fi standard. The wireless route module 113 creates a route mode 40 according to the Wi-Fi standard, and the wireless transceiver module 115 builds a plurality of first wireless connections with the first electrical products 13 according to the route mode 40. Accordingly, within the coverage area of the WLAN 1, the signal transmissions between the wireless transceiver module 115 and the first electrical products 13 all conform to the Wi-Fi standard. It shall be appreciated that the method in which the first signal 20 is generated, the route mode 40 is created according to the Wi-Fi standard and the first wireless connections are built according to the route mode 40 can be readily appreciated by those of ordinary skill in the art, and thus will not be further described herein.

The wireless route module 113 of this embodiment is implemented by either software, firmware, hardware, or a combination thereof In detail, because of the rapid development of software engineering technologies, the function that could have only been accomplished through firmware or hardware before can now also be accomplished through software without cost issues. In this embodiment, the wireless route module 113 implemented by only the software can achieve the same function (i.e., the wireless route function) without the need of additional hardware elements and, therefore, is a preferred implementation as compared to the wireless route module 113 implemented by the firmware or the hardware. It shall be appreciated that any electrical device having a wireless route function falls within the scope of the present invention whether the wireless route function is implemented by either software, firmware, hardware or a combination thereof.

After the plurality of first wireless connections with the first electrical products 13 are built by the wireless transceiver module 115 according to the route mode 40, the wireless transceiver module 115 transmits a first signal 22 to the first electrical products 13 via the first wireless connections so that each of the first electrical products 13 executes a first action in response to the first signal 22.

Furthermore, both the first signal 22 and the first action executed by each of the electrical products 13 may be related with the type of or functions of the electrical device 11 having a wireless route function. For example, if the electrical device 11 having a wireless route function is a wireless video/audio device, then the first signal 22 may comprise a video/audio message and each of the first electrical products 13 plays a video/audio content according to the first signal 22.

If the electrical device 11 having a wireless route function is a wireless data transmission device, then the first signal 22 may comprise a data message and each of the first electrical products 13 executes data processing according to the first signal 22. If the electrical device 11 having a wireless route function is a wireless control device, then the first signal 22 may comprise a control message and each of the first electrical products 13 performing a corresponding reaction according to the first signal 22. It shall be appreciated that instead of being limited to the aforesaid implementations, the electrical device 11 having a wireless route function may also be some other electrical devices having a wireless route function, the first signal 22 may also comprise some other messages, and each of the electrical products 13 may also execute some other actions.

To more clearly describe that each of the electrical products 13 executes the first action according to the first signal 22, a further description will be made with reference to an exemplary example hereinafter. In this exemplary example, the WLAN 1 serves a house, the electrical device 11 having a wireless route function is a video/audio monitor located within the house, and the first electrical products 13 include a smart phone, a flat panel computer and a handheld multi-media player that are located within the house.

In detail, when the video/audio monitor (i.e., the electrical device 11 having a wireless route function) detects an abnormal condition (e.g., a fire alarm), the wireless transceiver module 115 loads a video content and an audio content obtained from the monitor to the first signal 22 and then transmits the first signal 22 to the smart phone, the flat panel computer and the handheld multi-media player (i.e., the electrical products 13) via the first wireless connections. Then, the smart phone, the flat panel computer and the handheld multi-media player play the video content and the audio content monitored by the video/audio monitor, and perform a corresponding action according to the control message loaded in the first signal 22, such as sending an alarm signal (i.e., execute the first action). It shall be appreciated that the aforesaid exemplary example is only for the purpose of illustration rather than to limit the present invention.

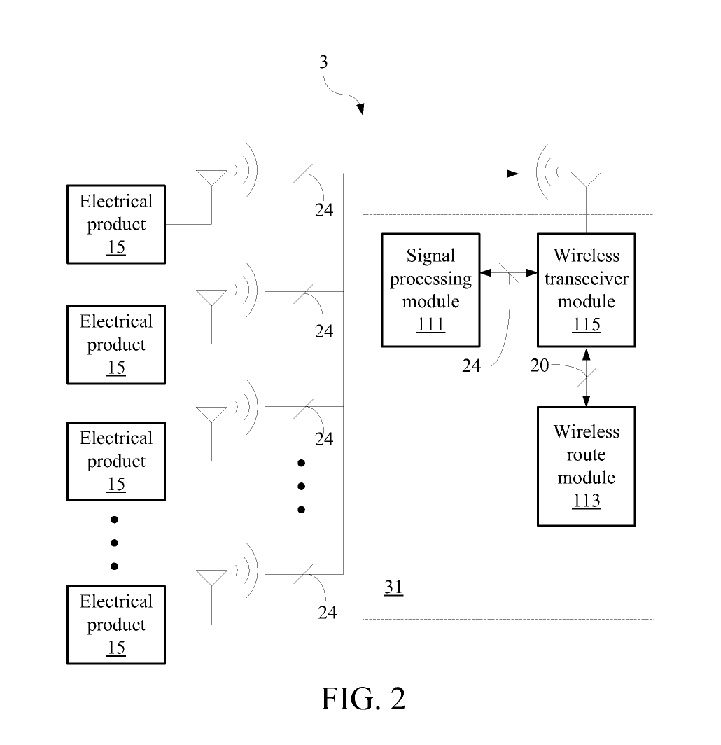

FIG. 2 illustrates the second embodiment of the present invention, which is a WLAN 3. Specifically, FIG. 2 is a schematic view illustrating the connections of the WLAN 3. It shall be appreciated that elements other than those that are particularly described in this embodiment may all be viewed as corresponding to those of the aforesaid embodiment. Accordingly, the reference numerals and descriptions of some of the elements in the aforesaid embodiment still apply to this embodiment, and identical reference numerals shall be considered to represent identical or similar elements, so descriptions thereof will be omitted herein. For the omitted descriptions, reference may be made to the aforesaid embodiment and they will not be further described in this embodiment.

As shown in FIG. 2, the WLAN 3 comprises an electrical device 31 having a wireless route function and a plurality of electrical products 15. It shall be appreciated that the electrical products 15 of FIG. 2 may be any electrical devices with a wireless transmitting/receiving function such as wireless video cameras, video doorbell devices, smart phones, flat panel/portable/desktop computers, or handheld multi-media players. The number of electrical products 15 is only for the purpose of illustration rather than to limit the present invention. Furthermore, the electrical products 15 may be viewed as the first electrical products of the first embodiment.

In this embodiment, the electrical device 31 having a wireless route function may be viewed as the electrical device 11 of the first embodiment. The electrical device 31 having a wireless route function comprises a signal processing module 111, a wireless route module 113, and a wireless transceiver module 115 electrically connected to the signal processing module 111 and the wireless route module 113. The wireless route module 113 is configured to create a route mode 20, and the wireless transceiver module 115 builds a plurality of wireless connections with the electrical products 15 according to the route mode 20. It shall be appreciated that the signal processing module 111, the wireless route module 113 and the wireless transceiver module 115 conform to the Wi-Fi standard. The wireless route module 113 is implemented by either software, firmware hardware, or a combination thereof.

This embodiment differs from the first embodiment in that the wireless transceiver module 115 of this embodiment receives a plurality of signals 24 from the electrical products 15 via the wireless connections. The signal processing module 111 executes an action in response to the signals 24. The signals 24 and the action executed by the signal processing module 111 may be related to the type of or functions of the electrical device 31 having a wireless route function.

For example, if the electrical device 31 having a wireless route function is a wireless video/audio device, then each of the signals 24 may comprise a video/audio message. The signal processing module 111 plays a video/audio content according to the signals 24. If the electrical device 31 having a wireless route function is a wireless data transmission device, then each of the signals 24 may comprise a data message and the signal processing module 111 executes data processing according to the signals 24.

If the electrical device 31 having a wireless route function is a wireless control device, then each of the signals 24 may comprise a control message. The signal processing module 111 executes a corresponding reaction according to the signals 24. It shall be appreciated that the electrical device 31 having a wireless route function may also be some other electrical devices having a wireless route function. The signals 24 may also comprise some other messages. The signal processing module 111 may also execute some other actions.

To more clearly describe how the electrical device 31 having a wireless route function executes an action in response to the signals 24, a further description will be made with reference to an exemplary example hereinafter. In this example, the WLAN 3 serves a classroom and perimeters thereof, the electrical device 31 having a wireless route function is a wireless video/audio player disposed within the classroom, and the electrical products 15 include a wireless video camera located outside the classroom and a flat panel computer located within the classroom.

The wireless video camera (i.e., an electrical product 15) can load a video content and an audio content that are monitored outside the classroom to a signal 24 and then transmit the signal 24 to the wireless video/audio player (i.e., the electrical device 31 having a wireless route function) disposed within the classroom; and the flat panel computer (i.e., another electrical product 15) can load a film to another signal 24 and then transmit the another signal 24 to the wireless video/audio player disposed within the classroom. Then, after the signals 24 are received, the wireless video/audio player can selectively play one of or simultaneously play both of the video content and the corresponding audio content monitored by the wireless video camera and the film transmitted by the flat panel computer in a split screen.

Furthermore, the wireless video/audio player may also execute a corresponding reaction according to the control message loaded in the signal 24 transmitted by the flat panel computer, e.g., decide which kind of content is to be played (i.e., execute the action).

The wireless video/audio player may sequentially play the video content and the audio content monitored by the wireless video camera and the film transmitted by the flat panel computer, and may also simultaneously play the video content and the audio content monitored by the wireless video camera and the film transmitted by the flat panel computer through a split-screen technology. It shall be appreciated that the aforesaid exemplary example is only for the purpose of illustration rather than to limit the present invention.

It shall be appreciated that in addition to the aforesaid description, the second embodiment can also execute all the operations and functions set forth in the aforesaid embodiment. The method in which the second embodiment executes these operations and functions can be readily appreciated by those of ordinary skill in the art based on the explanation of the aforesaid embodiment, and thus will not be further described herein.

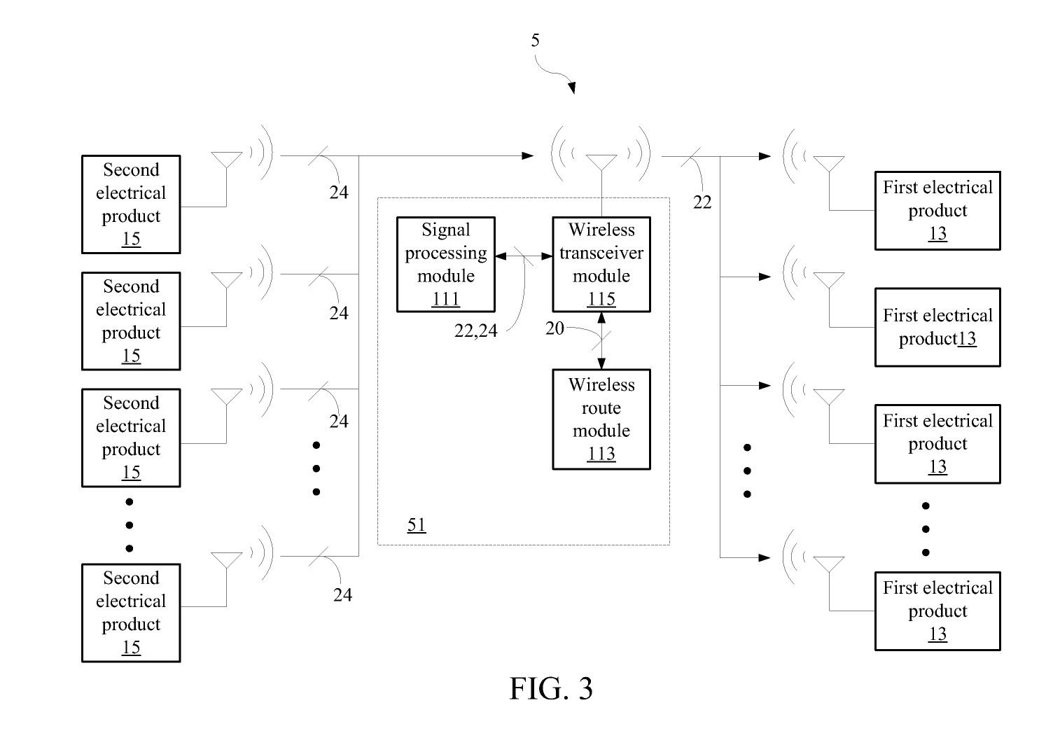

FIG. 3 illustrates the third embodiment of the present invention is a WLAN 5. Specifically, FIG. 3 is a schematic view illustrating the connections of the WLAN 5. It shall be appreciated that elements other than those that are particularly described in this embodiment may all be viewed as corresponding to those of the aforesaid embodiments. Accordingly, the reference numerals and descriptions of some of the elements in the aforesaid embodiments still apply to this embodiment, and identical reference numerals shall be considered to represent identical or similar elements, so descriptions thereof will be omitted herein. For the omitted descriptions, reference may be made to the aforesaid embodiments and they will not be further described in this embodiment.

As shown in FIG. 3, the WLAN 5 comprises an electrical device 51 having a wireless route function, a plurality of first electrical products 13 and a plurality of second electrical products 15. The second electrical products 15 may be regarded as the electrical products 15 of FIG. 2. It shall be appreciated that the first electrical products 13 of FIG. 3 may be any electrical devices with a wireless transmitting/receiving function such as smart phones, network TVs, flat panel/portable computers, handheld multi-media players or wireless video/audio receivers. The number of first electrical products 13 is only for the purpose of illustration rather than to limit the present invention.

Additionally, the second electrical products 15 of FIG. 3 may be any electrical devices with a wireless transmitting/receiving function such as wireless video cameras, video doorbell devices, smart phones, flat panel/portable/desktop computers, or handheld multi-media players. The number of second electrical products 15 is only for the purpose of illustration rather than to limit the present invention.

In this embodiment, the electrical device 51 having a wireless route function may be viewed as a combination of the electrical device 11 having a wireless route function of the first embodiment and the electrical device 31 having a wireless route function of the second embodiment. In detail, the electrical device 51 having a wireless route function comprises a signal processing module 111, a wireless route module 113, and a wireless transceiver module 115 electrically connected to the signal processing module 111 and the wireless route module 113. The signal processing module 111 is configured to generate a first signal 22, and the wireless route module 113 is configured to create a route mode 20.

The wireless transceiver module 115 builds a plurality of first wireless connections with the first electrical products 13 according to the route mode 20, and builds a plurality of second wireless connections with the second electrical products 15 according to the route mode 20. It shall be appreciated that the signal processing module 111, the wireless route module 113 and the wireless transceiver module 115 conform to the Wi-Fi standard. The wireless route module 113 is implemented by either software, firmware, hardware, or a combination thereof.

In this embodiment, the wireless transceiver module 115 transmits the first signal 22 to the first electrical products 13 via the first wireless connections so that each of the first electrical products 13 executes a first action in response to the first signal 22. The wireless transceiver module 115 further receives a plurality of signals 24 from the second electrical products 15 via the second wireless connections, and the signal processing module 111 further executes a second action in response to the signals 24.

It shall be appreciated that the method in which each of the first electrical products 13 of this embodiment executes the first action in response to the first signal 22 and how the signal processing module 111 executes the second action in response to the signals 24 can be readily appreciated by those of ordinary skill in the art based on the explanation of the aforesaid embodiments, and thus, will not be further described herein.

It shall be appreciated that in addition to the aforesaid description, the third embodiment can also execute all the operations and functions set forth in the aforesaid embodiments. The method in which the third embodiment executes these operations and functions can be readily appreciated by those of ordinary skill in the art based on the explanation of the aforesaid embodiments, and thus, will not be further described herein.

According to the above descriptions, the electrical device having a wireless route function of the present invention has a wireless route module built therein so that it can wirelessly connect and communicate with a plurality of electrical products simultaneously without the support of a conventional wireless router. Furthermore, because the wireless route module is specially used to provide the WLAN connection service and is built in the electrical device, the electrical device having a wireless route function of the present invention can effectively improve the problems in which conventional WLANs were liable to congestion and could not provide services for users anywhere and at any time.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. An electrical device having a wireless route function, comprising:
a signal processing module, being configured to generate a first signal;
a wireless route module, being configured to create a route mode; and
a wireless transceiver module, being electrically connected to the signal processing module and the wireless route module, and being configured to build a plurality of first wireless connections with a plurality of first electrical products according to the route mode and transmit the first signal to the first electrical products via the first wireless connections so that each of the electrical products executes a first action in response to the first signal.

2. The electrical device as claimed in claim 1, wherein the first signal comprises one of a video/audio message, a data message and a control message, and the first action comprises one of playing a first video/audio content according to the video/audio message, executing data processing according to the data message and performing a corresponding reaction according to the control message.

3. The electrical device as claimed in claim 1, wherein the wireless transceiver module is further configured to build a plurality of second wireless connections with a plurality of second electrical products according to the route mode and receive a plurality of second signals from the second electrical products via the second wireless connections, and the signal processing module further executes a second action in response to the second signals.

4. The electrical device as claimed in claim 3, wherein the first signal comprises one of a video/audio message, a data message and a control message, the first action comprises one of playing a first video/audio content according to the video/audio message, executing data processing according to the data message and performing a corresponding reaction according to the control message, each of the second signals comprises one of a video/audio message, a data message and a control message, and the second action comprises one of playing a second video/audio content according to the video/audio message, executing data processing according to the data message and performing a corresponding reaction according to the control message.

5. The electrical device as claimed in claim 4, wherein the second video/audio content is a split-screen video/audio content.

6. The electrical device as claimed in claim 1, wherein the wireless route module is implemented by one of a software, a firmware and a hardware.

7. The electrical device as claimed in claim 4, wherein the wireless route module is implemented by one of a software, a firmware and a hardware.

8. The electrical device as claimed in claim 1, wherein the signal processing module, the wireless route module and the wireless transceiver module conform to a Wireless Fidelity (Wi-Fi) standard.

9. The electrical device as claimed in claim 4, wherein the signal processing module, the wireless route module and the wireless transceiver module conform to a Wi-Fi standard.

10. An electrical device having a wireless route function, comprising:
a signal processing module;
a wireless route module, being configured to create a route mode; and
a wireless transceiver module, being electrically connected to the signal processing module and the wireless route module, and being configured to build a plurality of wireless connections with a plurality of electrical products according to the route mode and receive a plurality of signals from the electrical products via the wireless connections;
wherein the signal processing module executes an action in response to the signals.

11. The electrical device as claimed in claim 10, wherein each of the signals comprises one of a video/audio message, a data message and a control message, and the action comprises one of playing a video/audio content according to the video/audio message, executing data processing according to the data message and performing a corresponding reaction according to the control message.

12. The electrical device as claimed in claim 11, wherein the video/audio content is a split-screen video/audio content.

13. The electrical device as claimed in claim 10, wherein the wireless route module is implemented by one of a software, a firmware and a hardware.

14. The electrical device as claimed in claim 10, wherein the signal processing module, the wireless route module and the wireless transceiver module conform to a Wi-Fi standard.
